(19) United States
(12) Patent Application Publication
(10) Pub. No.: US 2005/0259352 A1
(43) Pub. Date: Nov. 24, 2005

(54) Bumper device for data storage apparatus

(76) Inventors: Stephen P. LeClair, Burnsville, MN (US); Steven D. Knopp, Savage, MN (US); James E. Angelo, Savage, MN (US); Fei Wang, Savage, MN (US); Michael D. Schroeder, Webster, MN (US); Peter R. Janik, Shakopee, MN (US); Matthew W. Jones, Bloomington, MN (US)

Correspondence Address: Seagate Technology LLC, 1280 Disc Drive, Shakopee, MN, 55379, US

(21) Appl. No.: 10/848,678

(22) Filed: May 19, 2004

(51) Int. Cl. G11B 33/14

(52) U.S. Cl. 360/97.02

(57) ABSTRACT

A bumper device is attached to a data storage apparatus for dampening externally originated shock loads. The disc drive apparatus comprises a base, a transducer assembly, and a printed circuit board assembly. The printed circuit board assembly is attached to an exterior surface of the base, and a bumper device is attached to the circuit board to engage external surfaces and to absorb shock loads created by an impact from such external surfaces.

### BACKGROUND OF THE INVENTION

The present invention relates to data storage devices, and in particular, it relates to a data storage apparatus having reduced susceptibility to externally originated shocks.

Disc storage devices are used in data processing systems for storing large amounts of information that can be accessed in milliseconds. Storage or retrieval of information is accomplished by a disc drive system that includes one or more read heads to read from one or more discs.

A disc drive system stores data on rotating media, for example a magnetic disc, and uses read heads suspended on a moving armature that read the data on the rotating media as the surface of the rotating media moves past them. The interface between the heads and the disc surface is extremely delicate.

Disc drive systems occasionally experience external shock loads, for example, by the user hitting the drive or dropping the drive prior to or during handling while installing the drive in a host device such as a computer case or laptop computer. If the frequency of the shock coincides with a resonance characteristic of the housing and/or the head disc assembly, the transmitted shock load may be substantial. This shock load may result in head to disc contact with potentially detrimental damage to the discs and/or head. Consequently, it is desirable to minimize the effects of external shock loads on the drive prior to the drive being installed in the host device.

Embodiments of the present invention provided solutions to this and other problems, and offers advantages over the prior art.

### SUMMARY OF THE INVENTION

The present invention includes a bumper attached to a data storage apparatus for dampening externally originated shock loads. The data storage apparatus comprises a transducer assembly having a base. A printed circuit board is attached to the base. At least one bumper is attached to at the circuit board. The bumper reduces the shock to the transducer assembly and printed circuit board assembly that may be encountered in transport or in installation of the data storage apparatus into a host device such as a computer cabinet. The bumper comprises a main body, having a proximal end that is attached to the printed circuit board, and a distal end for making the initial contact with an external, shock-producing surface prior to any other part of the data storage apparatus, thus reducing the shock transferred to the base and ultimately to the transducer assembly. In an alternate embodiment, a bumper may be installed on a printed circuit board that has at least one corner, and the bumper is attached proximate to the corner of the printed circuit board.

Other features and benefits that characterize the embodiments of the present invention will be apparent upon reading the following detailed description and review of the associated drawings.

### BRIEF DESCRIPTION OF THE DRAWINGS

FIG. 1 is an exploded perspective view of the present invention.

FIG. 2 is a perspective view of the bumper of the present invention on a printed circuit board assembly.

FIG. 3 is a sectional view taken along the line 3-3 in FIG. 2.

FIG. 4 is a graphical view showing the dampening effect of the present invention.

### DETAILED DESCRIPTION

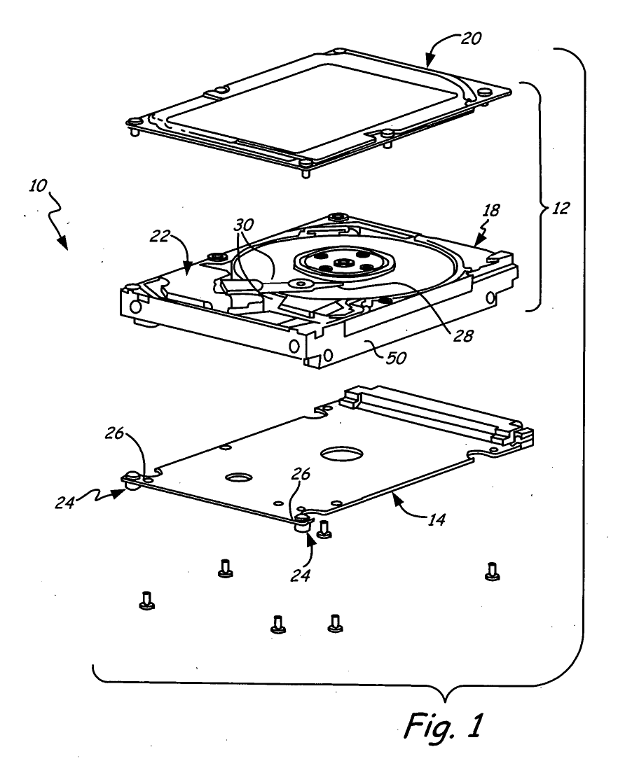

A disc drive apparatus of the present invention is generally indicated at in FIG. 1. Although a disc drive assembly is specifically illustrated, the present invention is applicable to other data storage devices such as a tape drive assembly having a moving transducer assembly to read data from a storage medium other than a disc. The disc drive apparatus 10 includes a head disc assembly (HDA) 12 and a printed circuit board assembly 14 (PCBA). The HDA 12 includes a base plate 18 and a top cover 20 secured together with a plurality of screws. The PCBA 14 is secured to the underside of the base plate 18. The PCBA 14 typically contains the drive control electronics circuitry and interface components for interfacing the disc drive apparatus 10 with other computer elements.

The HDA includes an actuator assembly 22 positioned on the base plate 18 under the cover 20. The actuator assembly includes a pair of heads 28 (one of which is shown) and actuator arms 30. The number of heads 28 and actuator arms 30 may vary depending on the number of discs that are employed within the disc drive apparatus 10. The particular configuration of the HDA 12 illustrated in the drawings is for exemplary purposes only and other configurations are included within the present invention.

The base plate 18 and the PCBA 14 have a generally rectangular configuration with corners 26. Bumpers 24 are attached to the PCBA 14 proximate the corners 26. The bumpers 24 are used to reduce the impact of externally introduced shock inputs to the PCBA and HDA. Such shock inputs occur during handling and/or installation of the disc drive apparatus within a host device such as a computer cabinet. Typically, when the disc drive apparatus is dropped or accidentally bumped against a hard surface, the corners 26 of the PCBA 14 that receive the shock input.

Such shock inputs are transmitted through the housing to the heads 28 and actuator arms 30 of the actuator assembly 22. Transmission of the shock may misalign the actuator arms 30 or cause the heads to vibrate and move to the point where a head may impact the surface of the disc to scratch the disc or damage the head, or both. In one embodiment of the invention, the actuator assembly 22 is located approximate to the end of the apparatus itself with bumpers 24. The bumpers 24 of the present invention reduce greatly the impact of such shocks on the actuator assembly 22 as well as other components by absorbing the energy input from the shock at a lower cost than prior art gaskets. In addition, the bumpers 24 provide design flexibility since no design changes to the disc drive apparatus itself need to be made to accommodate the bumpers 24. Further, the bumpers 24 do not act as an obstacle to any future design changes in the described apparatus.

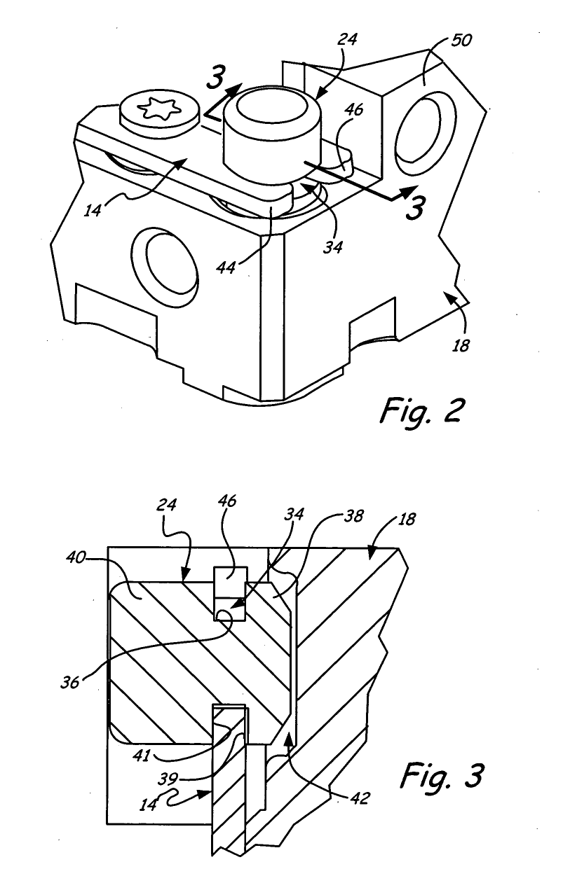

As best illustrated in FIGS. 2 and 3, the bumpers 24 are attached to the PCBA 14 by a frictional fit within slots 34 located at the two corners 26 of the PCBA 14. Fingers 44 and 46 define the slots 34. The bumpers 24 have a generally cylindrical shape with an annular slot 36 located between a base facing portion 38 and outwardly extending portion 40. The annular slot 36 is defined by opposite facing surfaces 39 and 41 of the base facing portion 38 and the outwardly extending portion, respectively. The annular slot 36 with surfaces 39 and 41 frictionally engage the fingers 44 and 46.

The base engaging portion 38 is positioned within a well 42 of the base 18. The outwardly extending portion 40 extends a distance preferably that is at least as high as a rail section 50 of the base 18. The outwardly extending portion 40 needs to be of at least a height of the rail portion 50 to ensure that the bumpers 24 are the first elements of the apparatus 10 that are engaged in any contact with an external surface that may cause a shock load. Likewise, the position of the bumpers 24 proximate a corner of the PCBA is such that the bumpers 24 are to be engaged before the PCBA or the base 18 when the corners 26 come in contact with another surface.

One material found suitable for the bumper of the present invention is a fluoroelastomer (FE 56210) sold by Dyneon, a subsidiary of 3M Company of St. Paul, Minn. The particular fluoroelastomer used has a durometer of approximately 60±5 shore “A”, a tensile strength of approximately 1350 psi, an elongation of approximately 250%, a modulus of approximately 260 psi at 0% and a compression set of approximately 20%. However, other types of materials such as other elastomers or rubbers that absorb and dissipate energy from shock impacts are included within the present invention.

One method of determining the dampening effect of the present invention is a drop test in which the disc drive apparatus is positioned with the PCBA 14 facing downwardly. The end of the disc drive apparatus opposite from the bumpers 24 is pivotally held while the other end of the disc drive apparatus containing the bumpers 24 is free to move. The actuator assembly 22 is located proximate the end that has the bumpers 24. The disc drive apparatus is permitted to swing about the pivot with the end of the disc drive apparatus containing the bumpers hitting a hard surface. An accelerometer is positioned on the disc drive apparatus proximate the actuator assembly location. The end of the disc drive apparatus that has the bumpers was raised to a 45° angle above a horizontal plane running through the pivot point and permitted to drop (pivot) until the bumper end hits the hard surface.

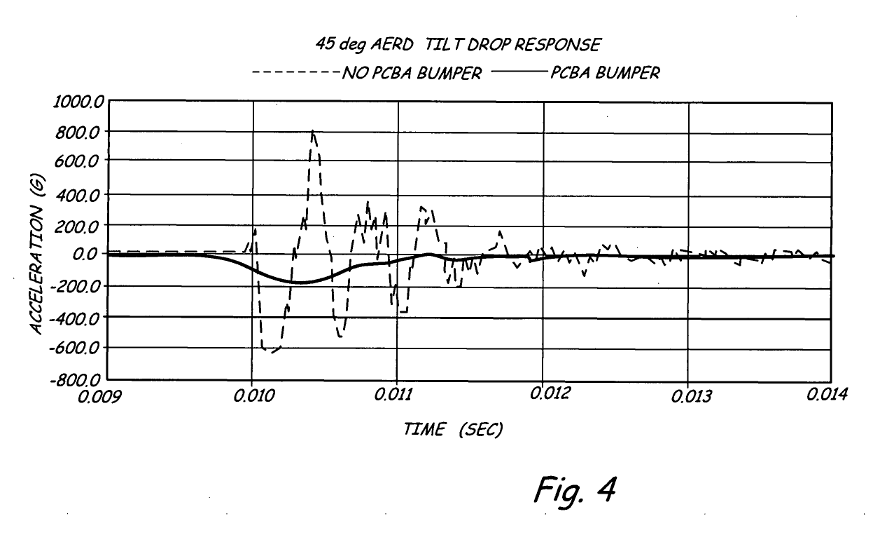

FIG. 4 graphically illustrates a comparative test performed with the disc drive apparatus being dropped without the bumpers 24 (broken lines), and with the bumpers 24 (solid line). As FIG. 4 illustrates, the impact response in G-force was reduced three times when using the bumpers 24 of the present invention. In addition, the duration of the impact response (initial peak) when bumpers were used was increased 10 fold to about 2 milliseconds when compared to the disc drive apparatus without bumpers (broken lines) that had a shorter impact response with a higher peak.

Although the present invention has been described with reference to preferred embodiments, workers skilled in the art will recognize that changes may be made in form and detail without departing from the spirit and scope of the invention.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the disc drive system while maintaining substantially the same functionality without departing from the scope and spirit of the present invention. Features shown in one embodiment can be appropriately adapted to other embodiments within the scope of the invention. In addition, although the preferred embodiment described herein is directed to a disc drive assembly and the use of at least one bumper to absorb external shock loads, it will be appreciated by those skilled in the art that the teachings of the present invention can be applied to other sensitive miniature devices, without departing from the scope and spirit of the present invention.

1. A data storage assembly comprising:
a transducer assembly having a base;
a printed circuit board assembly attached to the base; and
at least one bumper attached to the printed circuit board assembly for absorbing shock loads.

2. The data storage assembly of claim 1 wherein the printed circuit board assembly has at least one corner, and wherein the at least one bumper is attached to the printed circuit board assembly proximate the at least one corner.

4. The data storage assembly of claim 1 wherein the printed circuit board assembly has a slot and wherein the at least one bumper is attached to the printed circuit board assembly by engaging the slot.

5. The data storage assembly of claim 1 wherein the at least one bumper is made of an elastomer.

6. The data storage assembly of claim 1 wherein the at least one bumper extends sufficiently from the printed circuit board assembly to be an initial contact with another surface.

7. The data storage assembly of claim 2 wherein the bumper is positioned on the printed circuit board assembly proximate to a well in the base.

8. A shock absorbing device comprising a bumper for use with an electronic device, the electronic device having movable components, the bumper comprising:
a main body, having a proximal end that is attached to the electrical device; and
a distal end for engaging an external surface to absorb shock created by an impact with the external surface.

9. The shock absorbing device of claim 8 wherein the electronic device has at least one corner, and the bumper device is located proximate the at least one corner.

10. The shock absorbing device of claim 8 wherein the main body of the bumper is made of an elastomeric material.

11. A method of dissipating external shock loads to a disc drive assembly, the disc drive assembly comprising a base and a printed circuit board attached to an exterior surface of the base, the method comprising:
attaching a bumper to the printed circuit board assembly wherein the bumper is in initial contact with another surface.

12. The method of claim 11 further comprising attaching the bumper to the circuit board assembly such that the bumper extends a sufficient distance away from the circuit board assembly to be the initial contact with the another surface.

13. The method of claim 12 wherein the printed circuit board has at least two corners, and a bumper is attached to each corner such that each bumper is the initial contact with the another surface.

14. A data storage assembly comprising:
a transducer assembly having a base;
a printed circuit board assembly attached to the base; and
means for dampening an externally originated shock to the data storage assembly, the means for dampening being attached to the printed circuit board assembly in a manner such that the means for dampening is positioned for initial contact with another surface.

15. The data storage assembly of claim 14 wherein the base has an exterior surface and the printed circuit board is attached to the exterior surface.

16. The data storage assembly of claim 14 wherein the means for dampening is at least one bumper attached to the printed circuit board assembly.

17. The data storage assembly of claim 16 wherein the printed circuit board assembly has at least one corner and the at least one bumper is attached to the printed circuit board assembly proximate the at least one corner of the printed circuit board assembly.

18. The data storage assembly of claim 16 wherein the at least one bumper is made of an elastomer.

19. The data storage assembly of claim 16 wherein the at least one bumper extends sufficiently from the printed circuit board assembly to be the initial contact with another surface.
